(19) United States
(12) Patent Application Publication
(10) Pub. No.: US 2006/0127053 A1
(43) Pub. Date: Jun. 15, 2006

(54) Method and apparatus to automatically adjust audio and video synchronization

(76) Inventor: Hee-soo Lee, Suwon-si (KR)

Correspondence Address: Stanzione & Kim, LLP, 1st Fl., 1740 N St., NW, Washington, DC, 20036, US

(21) Appl. No.: 11/196,330

(22) Filed: Aug. 4, 2005

(30) Foreign Application Priority Data
Dec. 15, 2004 (JP) 2004-106544

(51) Int. Cl. H04N 7/52

(52) U.S. Cl. 386/96

(57) ABSTRACT

An automatic AV synchronization adjusting method and apparatus to automatically adjust a synchronization error between a video signal and an audio signal generated in an AV system. The method includes: generating video and audio test signals; measuring an audio delay amount from when the audio test signal is generated to when the audio is output form a speaker; measuring an video delay amount from when the video test signal is generated to when the video is displayed on a display device; determining a final audio delay amount by subtracting the audio delay amount from the video delay amount; and adjusting a delay of an audio signal generated by an AV source device based on the determined audio delay amount.

### CROSS-REFERENCE TO RELATED APPLICATIONS

This application claims the benefit of Korean Patent Application No. 2004-106544, filed on Dec. 15, 2004, in the Korean Intellectual Property Office, the disclosure of which is incorporated herein in its entirety by reference.

### BACKGROUND OF THE INVENTION

1. Field of the Invention

The present general inventive concept relates to an audio/video (AV) playback system, and more particularly, to an automatic AV synchronization adjusting method and apparatus to automatically adjust a synchronization error between a video signal and an audio signal generated in an AV system.

2. Description of the Related Art

An AV system generally reproduces audio and video signals by connecting independent devices, such as a TV and an audio system, to each other. In these AV systems, a video signal reproduced by a display device and an audio signal reproduced by speakers may not be synchronized due to differences between processing times and/or signal paths.

FIG. 1 is a block diagram of a conventional AV system.

An AV source device 110 reads an AV signal from a disc or tape as a DVD player or a VTR and outputs the read signal to external devices. Here, the AV signal is in a synchronized state.

A video display device 120 visually displays a video signal input from the AV source device 110 through a display panel such as a TV set or a monitor.

An audio processing device 130 which includes a delay unit 132, an amplifier 134, and various signal processors (not shown), delays an audio signal generated by the AV source device 110 for a predetermined amount of time, and outputs the delayed audio signal to a speaker 140 after predetermined signal processing.

In the AV system illustrated in FIG. 1, the video signal is directly output to the video display device 120, whereas the audio signal is output to the speaker after passing through the delay unit 132, the amplifier 134, and the various signal processors. Here, a synchronization error occurs between the video displayed on the video display device 120 and the sound output from the speaker 140. For example, the video signal is delayed for around 3 to 4 frames (51 to 68 ms) from when the video is reproduced by the AV source device 110 to when the video is displayed on the video display device 120, whereas the audio signal is delayed for 3 to 4 samples (63 to 84 μs) when the audio is reproduced by the AV source device 110 to when the sound is output from the speaker 140. As a result, in the AV system illustrated in FIG. 1, the video signal is generally delayed for at least 50 ms longer than the audio signal.

Thus, for a conventional AV system, a user is required to determine a delay between audio and video during listening to the video from the video display device 120 and hearing the sound from the speaker 140 and to compensate for the delayed time in the audio processing device 130. The amount of time delay in the video display device 120 is commonly greater than in the audio processing device 130. To compensate for this, the user delays the audio signal for a predetermined time by manually adjusting a delay value of the delay unit 132 included in the audio processing device 130.

However, in a conventional AV synchronization adjusting method, since a user should determine whether audio and video are synchronized and how a delay of an audio signal differs from a delay of a video signal, inconvenience to the user is caused. Moreover, a user who is unfamiliar with use of electronic devices the AV system in a state in which an AV synchronization error is not compensated or asks a service center about the AV synchronization error.

### SUMMARY OF THE INVENTION

The present Your Ref. No.: SH-23510-US provides an automatic AV synchronization adjusting method and apparatus to automatically adjust a synchronization error between a video signal and an audio signal generated in an AV system.

The present Your Ref. No.: SH-23510-US also provides an AV system to which the automatic AV synchronization adjusting method and apparatus is applied.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing an AV synchronization adjusting method in an AV system, the method including: generating video and audio test signals; measuring an audio delay amount from when the audio test signal is generated to when the audio is output from a speaker; measuring an video delay amount from when the video test signal is generated to when the video is displayed on a display device; determining a final audio delay amount by subtracting the audio delay amount from the video delay amount; and adjusting a delay of an audio signal generated by an AV source device based on the determined audio delay amount.

The foregoing and/or other aspects and advantages of the present general inventive concept are also achieved by providing an AV system including: a signal source device to reproduce an AV signal from a predetermined recording medium; a display device having a video detector in front of a screen; a microphone; a speaker; an AV receiver to generate an audio test signal and a video test signal, to measure delay amounts of audio and video signals by detecting the audio test signal and the video test signal input via the microphone after passing through the speaker and a video-to-audio converter, respectively, and to delay an audio signal generated by the signal source device based on a final audio delay amount obtained by subtracting the audio delay amount from the video delay amount.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram of a conventional AV system;

FIG. 2 is a block diagram of an AV system according to an embodiment of the present general inventive concept;

FIGS. 3A and 3B are an exterior view and a detailed diagram of a video-to-audio converter of FIG. 2; and

FIGS. 4A through 4C are waveform diagrams illustrating detection of the amount of AV synchronization errors according to an embodiment of the present general inventive concept.

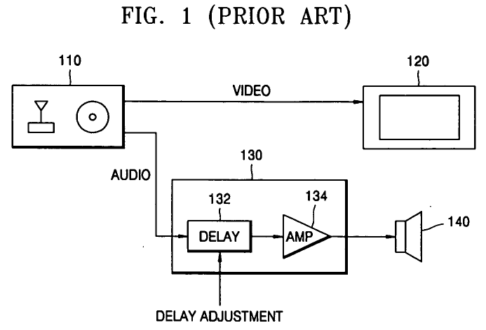

### DETAILED DESCRIPTION OF THE PREFERRED EMBODIMENTS

Hereinafter, embodiments of the present invention will now be described with reference to the accompanying drawings.

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

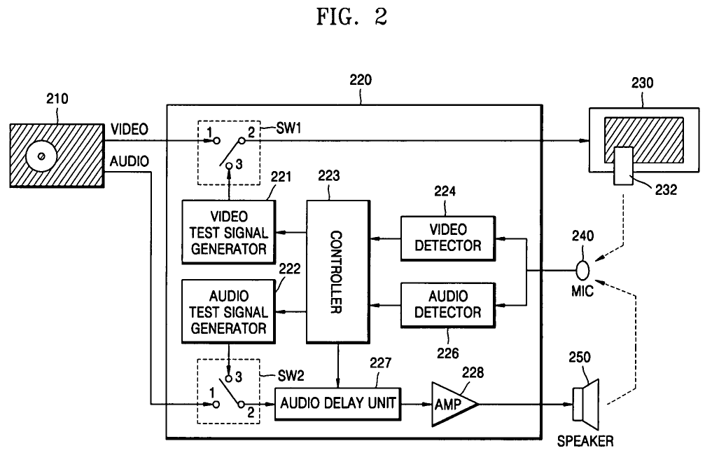

FIG. 2 is a block diagram of an AV system according to an embodiment of the present invention.

Referring to FIG. 2, the AV system includes an AV source device 210, a display device 230, an AV processing device 220, a microphone 240, and a speaker 250.

The AV source device 210 includes a DVD player or VTR, reads AV data from a recording medium such as a disc or tape, and outputs the read AV data to the AV processing device 220.

The display device 230 receives a video signal output from the AV processing device 220 and visually displays the video on a display panel such as a TV set or monitor. To measure a delay amount of the video signal, a video-to-audio converter 232 is attached in front of the screen of the display device 230 and converts the video to an audio signal. The video-to-audio converter 232 converts brightness information of a picture to an electrical signal and generates sound by generating a predetermined frequency signal from when a signal level greater than a threshold value is sensed.

The speaker 250 reproduces sound from an audio signal which is amplified by the AV processing device 220.

The microphone 240 senses the sound output from the speaker 250 and the sound output from a speaker of the video-to-audio converter 232.

The AV processing device 220 delays and amplifies the audio signal input from the AV source device 210 and outputs the delayed and amplified audio signal to the speaker 250. Also, the AV processing device 220 outputs the video signal input from the AV source device 210 to the display device 230. In addition, the AV processing device 220 determines a delay amount of an audio signal input from the AV source device 210 using the audio signal generated by the video-to-audio converter 232 attached to the display device 230. A detailed operation of the AV processing device 220 will now be described.

A controller 223 determines an initial audio delay amount by selecting a video test signal and an audio test signal by switching second contact points of first and second switches SW1 and SW2 to third contact points, respectively.

A video test signal generator 221 generates the video test signal, such as a black/white image, in response to a video test driving signal from the controller 223. Here, the video test signal is converted to a predetermined frequency signal (discriminated from an audio test signal) by the video-to-audio converter 232 attached to the display device 230.

An audio test signal generator 222 generates an audio test signal having a frequency f1(HZ) in response to an audio test driving signal from the controller 223. Here, the audio test signal is output to the speaker 250 after passing through an audio delay unit 227 and an amplifier 228.

The video test signal and the audio test signal may be generated either simultaneously or separately.

An audio detector 226 detects an audio signal input from the microphone 240. For example, the audio detector 226 includes a band pass filter having a frequency f1(HZ).

A video detector 224 detects the predetermined frequency signal corresponding to a video-to-audio-converted signal input from the microphone 240. For example, the video detector 224 may include a band pass filter having a frequency 2×f1(HZ) in order to discriminate the video test signal from the audio test signal.

The controller 223 measures an audio delay amount between the audio test signal detected by the audio detector 226 and the audio test signal generated by the audio test signal generator 222 and measures a video delay amount between the predetermined frequency signal detected by the video detector 224 and the video test signal generated by the video test signal generator 221. The controller 223 determines a final audio delay amount by subtracting the measured audio delay amount from the measured video delay amount.

The audio delay unit 227 delays the audio signal generated by the AV source device 210 for a predetermined amount of time based on the final audio delay amount determined by the controller 223.

After measurement of the audio delay amount is completed, the controller 223 selects the audio signal and video signal generated by the AV source device 210 by switching the second contact points of the first and second switches SW1 and SW2 to first contact points, respectively.

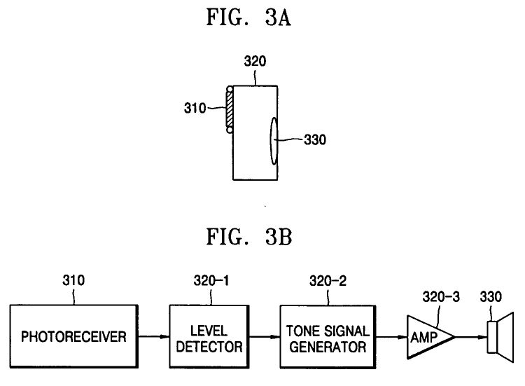

FIGS. 3A and 3B are an exterior view and a detailed diagram of the video-to-audio converter 232 of FIG. 2.

Referring to FIG. 3A, the video-to-audio converter 232 includes a photoreceiver 310, a main body 320, and a speaker 330 and is attached in front of the screen of the display device 230.

Referring to FIG. 3B, the photoreceiver 310 detects light eradiated from the screen of the display device 230 and converts the light to an electrical signal.

A level detector 320-1 detects a signal level greater than a threshold from the electrical signal generated by the photoreceiver 310.

A tone signal generator 320-2 generates a tone signal of a predetermined frequency (ai.e., a frequency of 2×f1(Hz)) for a predetermined period from when the signal level greater than the threshold is detected by the level detector 320-1.

An amplifier 320-3 amplifies the tone signal generated by the tone signal generator 320-2 up to a predetermined level.

The speaker 330 reproduces sound from the tone signal amplified by the amplifier 320-3.

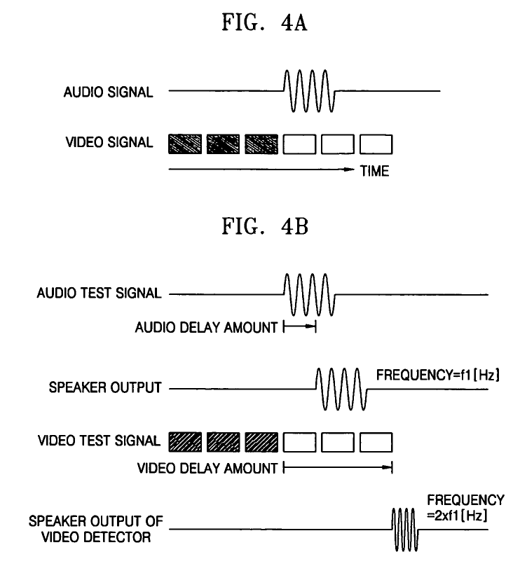

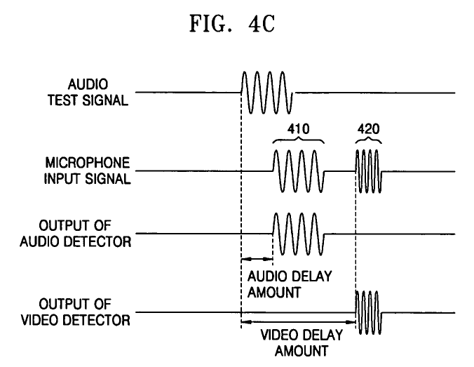

FIGS. 4A through 4C are waveform diagrams illustrating detection of AV synchronization error amounts according to an embodiment of the present general inventive concept.

Referring to FIG. 4A, the controller 223 outputs audio and video test signals by driving the audio and video test signal generators 221 and 222. For example, the audio test signal is a tone signal having a frequency f1(Hz), and the video test signal is a black and white image.

Referring to FIG. 4B, a signal having a frequency f1(Hz) is output from the speaker 250, and a signal of having a frequency 2×f1(Hz) is output from the video-to-audio converter 232 attached to the display device 230.

Referring to FIG. 4C, an audio test signal 410 having a frequency f1(Hz) and a video test signal 420 having a frequency 2×f1(Hz) are input to the microphone 240. Here, finally output audio and video delay amounts can be measured based on the originally generated audio and video test signal.

The audio detector 226 detects the audio test signal 410 using a band pass filter having a frequency f1(Hz), and the video detector 224 detects the video test signal 420 using a band pass filter having a frequency 2×f1(Hz). The controller 223 measures video and audio delay amounts using the video detector 224 and the audio detector 226 and determines an adjusted audio delay amount. That is, the adjusted audio delay amount is obtained by subtracting the measured audio delay amount from the measured video delay amount.

The embodiments of the present general inventive concept can be written as computer programs and can be implemented in general-use digital computers that execute the programs using a computer readable recording medium. Examples of the computer readable recording medium include magnetic storage media (e.g., ROM, floppy disks, hard disks, etc.), optical recording media (e.g., CD-ROMs, DVDs, etc.), and storage media such as carrier waves (e.g., transmission through the internet). The computer readable recording medium can also be distributed over network coupled computer systems so that the computer readable code is stored and executed in a distributed fashion.

As described above, according to embodiments of the present general inventive concept, an AV synchronization error in an AV system can be automatically compensated by measuring audio and video delay amounts using a microphone used for sound field space compensation of an AV receiver or level compensation of a speaker. In addition, a picture signal from a display device can be wirelessly detected to measure a delay amount of a video signal.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An audio/video (AV) synchronization adjusting method in an AV system, the method comprising:
generating video and audio test signals;
measuring an audio delay amount from when the audio test signal is generated to when the audio is output from a speaker;
measuring a video delay amount from when the video test signal is generated to when the video is displayed on a display device;
determining an adjusted audio delay amount by subtracting the audio delay amount from the video delay amount; and
adjusting a delay of an audio signal generated by an AV source device based on the determined adjusted audio delay amount.

2. The method of claim 1, wherein in the measuring of the audio delay amount, an audio delay amount from when the audio test signal is generated to when the audio is input to a microphone via the speaker is measured.

3. The method of claim 1, wherein the measuring of the video delay amount comprises:
converting the video test signal to an audio signal using a video-to-audio converter attached to the display device; and
measuring a video delay amount from when the video test signal is generated to when the converted audio signal is output from the video-to-audio converter.

4. The method of claim 3, wherein when in the video-to-audio converting, if the video test signal is input to the display device, brightness of a picture is sensed, the picture brightness information is converted to an electrical signal, a signal level greater than a threshold is detected from the electrical signal, a signal of a predetermined frequency is generated for a predetermined period from when the signal level greater than the threshold is detected, the signal of the predetermined frequency is reproduced to sound.

5. An audio/video (AV) synchronization adjusting apparatus comprising:
a signal generator to generate an audio test signal and a video test signal and to output the generated audio and video test signals to a speaker and a display device, respectively;
a signal detector to detect audio and video test signals input from a microphone via the speaker and a video-to-audio converter of the display device, respectively;
a controller to measure delay amounts between the audio and video test signals detected by the signal detector and the audio and video test signals generated by the signal generator, respectively, and to calculate an audio delay amount by subtracting the measured audio delay amount from the measured video delay amount; and
an audio delay unit to delay an audio signal generated by an AV source device based on the audio delay amount calculated by the controller.

6. The apparatus of claim 5, wherein the video-to-audio converter, which is attached in front of the screen of the display device, comprises:
a photoreceiver to detect light eradiated from the screen and to convert the light to an electrical signal;
a level detector to detect a signal level greater than a threshold from the electrical signal converted by the photoreceiver;
a signal generator to generate a signal of a predetermined frequency for a predetermined period from when the signal level greater than the threshold is detected; and
a speaker to reproduce sound from the signal generated by the signal generator.

7. An audio-video (AV) system comprising:
a signal source device to reproduce an AV signal from a predetermined recording medium;
a display device having a video detector in front of a screen;
a microphone;
a speaker;
an AV receiver to generate an audio test signal and a video test signal, to measure delay amounts of audio and video signals by detecting the audio test signal and the video test signal input via the microphone after passing through the speaker and a video-to-audio converter, respectively, and to delay an audio signal generated by the signal source device based on a final audio delay amount obtained by subtracting the audio delay amount from the video delay amount.

8. The AV system of claim 7, wherein the video-to-audio converter comprises:
a photoreceiver to detect light eradiated from the screen and to convert the light to an electrical signal;
a level detector to detect a signal level greater than a threshold from the electrical signal converted by the photoreceiver;
a signal generator to generate a signal of a predetermined frequency for a predetermined period from when the signal level greater than the threshold is detected; and
a speaker to reproduce sound from the signal generated by the signal generator.

9. An audio/video (AV) synchronization adjusting method in an AV system, the method comprising:
generating video and audio test signals;
measuring an audio output delay amount from a speaker based on the generated audio test signal;
measuring a video delay amount from a display device based on the generated video test signal;
determining an adjusted audio delay amount from a difference between the audio delay amount and the video delay amount; and
adjusting a delay of an audio signal generated by an AV source device based on the determined adjusted audio delay amount.

10. An automatic audio/video (AV) synchronization apparatus, comprising:
an AV source device to output an AV signal;
a display device including a video-to-audio converter that generates a predetermined frequency signal from brightness information of a video signal of the AV signal; and
an AV processing device to generate an audio test signal and a video test signal, to measure delay amounts of audio and video signals of the AV signal by detecting the audio test signal and the video test signal input via a microphone after passing through a speaker and the video-to-audio converter, respectively, and to delay an audio signal generated by the AV source device based on an adjusted audio delay amount obtained by calculating a difference between the audio delay amount and the video delay amount.

11. The automatic audio/video (AV) synchronization apparatus of claim 10, wherein the AV processing device comprises:
a video test signal generator to generate the video test signal in response to a received video test driving signal;
an audio test signal generator to generate the audio test signal in response to a received audio test driving signal;
an audio detector to detect an audio signal input from the microphone;
a video detector to detect the predetermined frequency signal input from the microphone;
and a controller to measure the delay amounts of the audio and video signals of the AV signal by detecting the audio test signal and the video test signal input via the microphone after passing through the speaker and the video-to-audio converter, respectively, and to calculate the adjusted audio delay amount; and
a delay unit to delay the audio signal of the AV signal output by the AV source device.

12. The automatic audio/video (AV) synchronization apparatus of claim 11, wherein the controller generates the audio and video test driving signals.

13. A computer readable storage medium containing an audio/video (AV) synchronization adjusting method in an AV system, the method comprising:
generating video and audio test signals;
measuring an audio delay amount from when the audio test signal is generated to when the audio is output from a speaker;
measuring a video delay amount from when the video test signal is generated to when the video is displayed on a display device;
determining an adjusted audio delay amount by subtracting the audio delay amount from the video delay amount; and
adjusting a delay of an audio signal generated by an AV source device based on the determined adjusted audio delay amount.

14. A computer readable storage medium containing an audio/video (AV) synchronization adjusting method in an AV system, the method comprising:
generating video and audio test signals;
measuring an audio output delay amount from a speaker based on the generated audio test signal;
measuring a video delay amount from a display device based on the generated video test signal;
determining an adjusted audio delay amount from a difference between the audio delay amount and the video delay amount; and
adjusting a delay of an audio signal generated by an AV source device based on the determined adjusted audio delay amount.
